(19) United States
(12) Patent Application Publication
(10) Pub. No.: US 2012/0069432 A1
(43) Pub. Date: Mar. 22, 2012

(54) OPTICAL DEVICE FOR COUPLING TO A CAMERA LENS TO FORM A VISUAL OBSERVATION SYSTEM

(75) Inventor: Chao-Wen LIANG, Taichung City (TW)

(73) Assignee: TONTA ELECTRO OPTICAL CO., LTD., Taichung City (TW)

(21) Appl. No.: 13/235,104

(22) Filed: Sep. 16, 2011

Related U.S. Application Data
(60) Provisional application No. 61/384,250, filed on Sep. 18, 2010.

(51) Int. Cl. G02B 23/02; G02B 23/16

(52) U.S. Cl. 359/401

(57) ABSTRACT

An optical device is adapted for coupling to a camera lens so as to form a visual observation system. The optical device includes a housing, a connecting unit disposed at the housing, a first lens set disposed in the housing and having a negative optical power, a prism unit located at an image side of the first lens set in the housing, and a second lens set located at an image side of the prism unit in the housing and having a positive optical power. The connecting unit includes a camera lens bayonet for connecting to the camera lens. The prism unit has a light-entrance surface and a light-exit surface. An image formed by light beams exiting the light-exit surface is erected with respect to an inverted image formed by light beams entering the light-entrance surface.

### CROSS-REFERENCE TO RELATED APPLICATION

This application claims priority of U.S. Provisional Application No. 61/384,250, filed on Sep. 18, 2010.

### BACKGROUND OF THE INVENTION

1. Field of the Invention

The present invention relates to an optical device, more particularly to an optical device adapted for coupling to a camera lens so as to form a visual observation system.

2. Description of the Related Art

A current single-lens reflex camera is suitable for taking pictures of objects at different distances in combination with different camera lenses of different focal lengths. Generally, a camera lens with a longer focal length, such as a telephoto lens, is usually used for taking pictures of wild animals at remote distances so as to avoid disturbing and frightening targets whose images are being captured. In this situation, a photographer usually uses a telescope which consumes little or no electricity and which is more comfortable to use when observing locations and behavior of the wild animals with relative ease. Therefore, the photographer needs to carry a telescope in addition to a single-lens reflex camera and relevant equipments.

For this reason, an optical device for use with a camera lens having a longer focal length for satisfying a need for observing remote objects is the subject of this invention.

### SUMMARY OF THE INVENTION

Therefore, an object of the present invention is to provide an optical device adapted for coupling to a camera lens so as to form a visual observation system.

Accordingly, the optical device of the present invention comprises a housing, a connecting unit, a first lens set, a prism unit, and a second lens set. The connecting unit is disposed at the housing and includes a camera lens bayonet for connecting to the camera lens. The first lens set is disposed in the housing, and has a negative optical power. The prism unit is located at an image side of the first lens set in the housing. The prism unit has a light-entrance surface and a light-exit surface. An image formed by light beams exiting the light-exit surface is erected with respect to an inverted image formed by light beams entering the light-entrance surface. The second lens set is located at an image side of the prism unit in the housing. The second lens set has a positive optical power. The optical device satisfies:

3 mm<L₁<15 mm,

27 mm<p<44 mm,

in which, L1 represents a distance from a lens contact surface of the camera lens bayonet which is away from the first lens set to an object side surface of the first lens set, and p represents a distance from the object side surface of the first lens set to a camera lens imaging plane of the camera lens. The camera lens imaging plane is located within an optical path of the prism unit.

An effect of the present invention resides in that a position of the camera lens imaging plane is adjusted toward the image side, and optical flux through the prism unit is effectively increased via the first lens set, that the inverted image of the first lens set is erected via the prism unit so as to facilitate observation by users, and that the second lens set magnifies the target image from the optical device and the camera lens. Therefore, the optical device of the present invention may be coupled to the camera lens so as to function as a visual observation system.

Another object of the present invention is to provide an optical device which is adapted for coupling to a camera lens and to a second lens set having a positive optical power so as to form a visual observation system and which has a modular structure.

Accordingly, the optical device of the present invention comprises a housing, a connecting unit, a first lens set, and a prism unit. The connecting unit is disposed at the housing and includes a camera lens bayonet for connecting to the camera lens. The first lens set is disposed in the housing, and has a negative optical power. The prism unit is located at an image side of the first lens set in the housing. The prism unit has a light-entrance surface and a light-exit surface. An image formed by light beams exiting the light-exit surface is erected with respect to an inverted image formed by light beams entering the light-entrance surface. The optical device satisfies:

3 mm<L₁<15 mm,

27 mm<p<44 mm,

in which, L1 represents a distance from a front contact surface of the camera lens bayonet which is away from the first lens set to an object side surface of the first lens set, and p represents a distance from the object side surface of the first lens set to a camera lens imaging plane of the camera lens. The camera lens imaging plane is located within an optical path of the prism unit.

An effect of the present invention resides in that a position of the camera lens imaging plane is adjusted toward the image side, and optical flux through the prism unit is effectively increased via the first lens set, that the inverted image of the first lens set is erected via the prism unit so as to facilitate observation by users, and that the second lens set magnifies the remote target image from the optical device and the camera lens. Therefore, the optical device of the present invention may not only couple to the camera lens and the second lens set so as to function as a visual observation system, but may also be used with different second lens sets so as to achieve a modular structure.

### BRIEF DESCRIPTION OP THE DRAWINGS

Other features and advantages of the present invention will become apparent in the following detailed description of the four preferred embodiments with reference to the accompanying drawings, of which:

FIG. 1 is an exploded perspective view illustrating a first preferred embodiment of an optical device for coupling to a camera lens to form a visual observation system according to the present invention;

FIG. 2 is a perspective view of the first preferred embodiment according to the present invention;

FIG. 3 is a side view illustrating a state of the first preferred embodiment after coupling to the camera lens;

FIG. 4 is a partly sectional view illustrating a first lens set, a prism unit, and a second lens set of the first preferred embodiment;

FIG. 5 is a schematic view illustrating the first lens set, the prism unit, and the second lens set of the first preferred embodiment;

FIG. 6 are ray fan plots illustrating aberrations of the first preferred embodiment corresponding to different relative image heights;

FIG. 7 is a schematic view illustrating a second preferred embodiment of the optical device according to the present invention;

FIG. 8 are ray fan plots illustrating aberrations of the second preferred embodiment corresponding to different relative image heights;

FIG. 9 is a schematic view illustrating a third preferred embodiment of the optical device according to the present invention;

FIG. 10 are ray fan plots illustrating aberrations of the third preferred embodiment corresponding to different relative image heights;

FIG. 11 is a schematic view illustrating a fourth preferred embodiment of the optical device according to the present invention; and

FIG. 12 are ray fan plots illustrating aberrations of the fourth preferred embodiment corresponding to different relative image heights.

### DETAILED DESCRIPTION OF THE PREFERRED EMBODIMENTS

Before the present invention is described in greater detail, it should be noted that like elements are denoted by the same reference numerals throughout the disclosure.

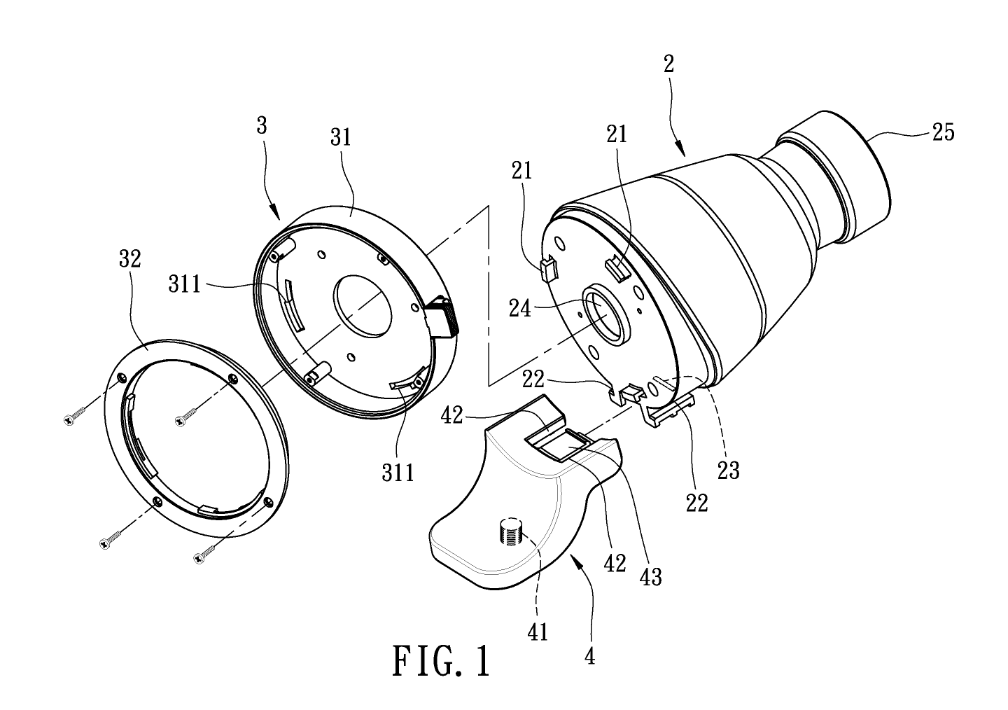

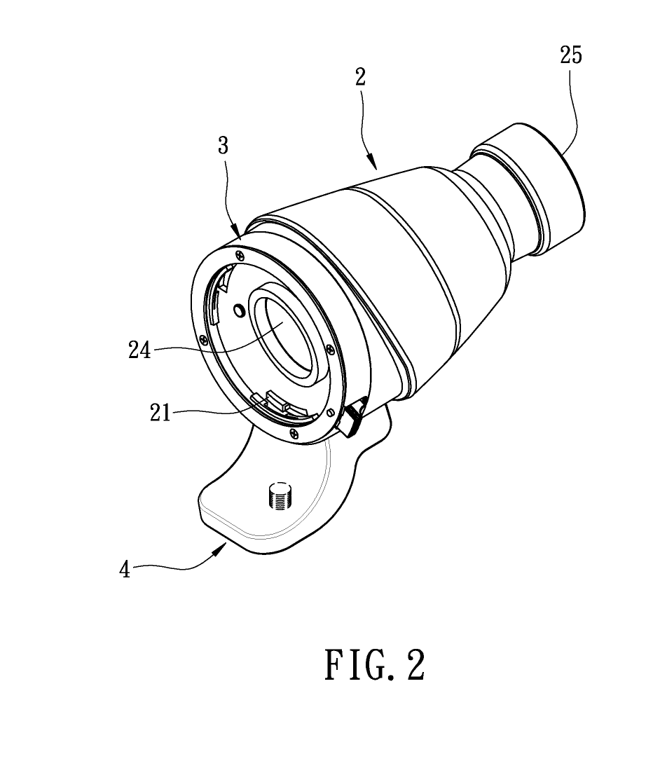

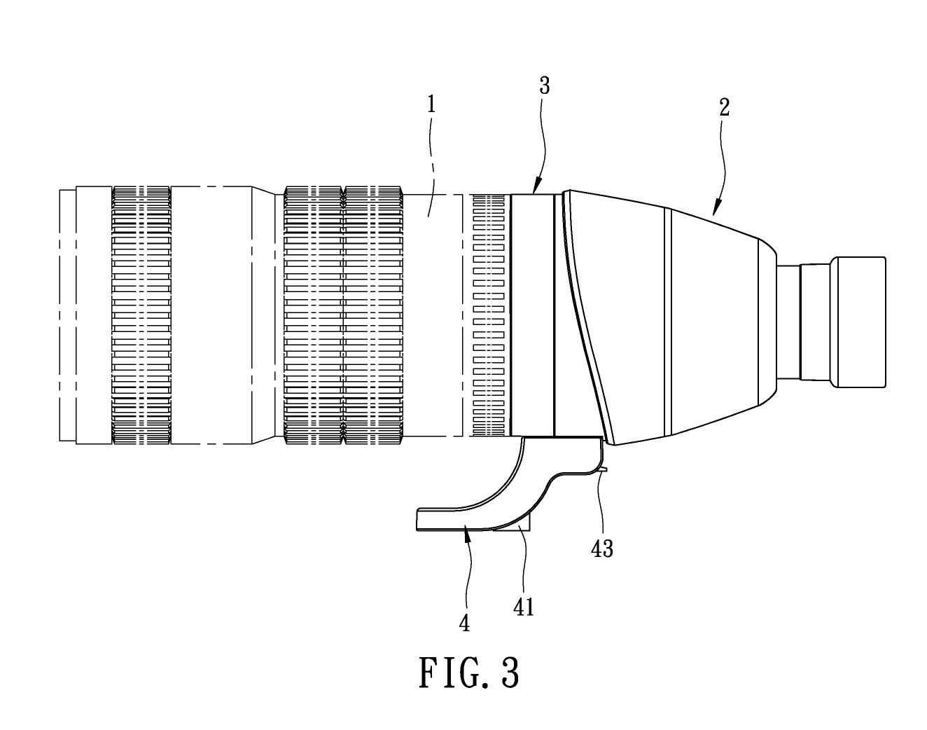

Referring to FIG. 1 to FIG. 4, a first preferred embodiment of an optical device for coupling to a camera lens so to form a visual observation system, according to the present invention, is adapted for coupling to a camera lens 1. The optical device comprises a housing 2, a connecting unit 3, a tripod coupler 4, a first lens set 5, a prism unit 6 and a second lens set 7.

The housing 2 includes three first connecting parts 21, a housing joint part 22, a housing engaging part 23, a light-entrance aperture 24, and a viewing aperture 25 for observation by a user, In the first preferred embodiment, each of the first connecting parts 21 is a substantially L-shaped part, the housing joint part 22 has a pair of guiding grooves, and the housing engaging part 23 is a ridge.

The connecting unit 3 is disposed at a front side of the housing 2, which faces objects to be observed, for coupling with the camera lens 1. The connecting unit 3 includes a ring body 31 disposed at the housing 2, and a camera lens bayonet 32 fastened to the ring body 31. The ring body 31 includes three second connecting parts 311 corresponding in position to the first connecting parts 21. In the first preferred embodiment, the second connecting parts 311 are slots for insertion of and connection with the first connecting parts 21. The second connecting parts 311 are removably connected to the first connecting parts 21 to secure removably the ring body 31 to the housing 2. It should be noted that the design of the ring body 31 and the first connecting parts 21 of the housing 2 is for modular replacement of different camera lens bayonets 32 corresponding to different forms of the camera lens 1. However, if the design of modular replacement is not needed, the first connecting parts 21 and the ring body 31 may be omitted. In this way, the camera lens bayonet 32 may be directly secured to the housing 2.

The tripod coupler 4 is disposed at the housing 2. The tripod coupler 4 includes a mount part 41 for mounting the tripod coupler 4 to a tripod (not shown), a coupler joint part 42 corresponding in position to the housing joint part 22, and a coupler engaging part 43 corresponding in position to the housing engaging part 23. In the first preferred embodiment, the coupler joint part 42 is a pair of guiding tongues for engaging the guiding grooves (i.e., the housing joint part 22), the coupler engaging part 43 is a hook for engaging the ridge (i.e., the housing engaging part 23), and the mount part 41 is a threaded hole. The coupler engaging part 43 is removably connected to the housing engaging part 23 to secure removably the tripod coupler 4 to the housing 2. It should be noted that considering each of the optical device of the present invention and the camera lens 1 has its own center of gravity, and a center of gravity of a combination of the optical device and the camera lens 1 lies between the center of gravity of the optical device and the center of gravity of the camera lens 1, the mount unit 41 for mounting the tripod coupler 4 to the tripod should be located between the center of gravity of the optical device and the center of gravity of the camera lens 1 so as to achieve weight balance. Preferably, a position of the mount unit 41 is closer to the center of gravity of the camera lens 1 with respect to the center of gravity of the optical device of the present invention.

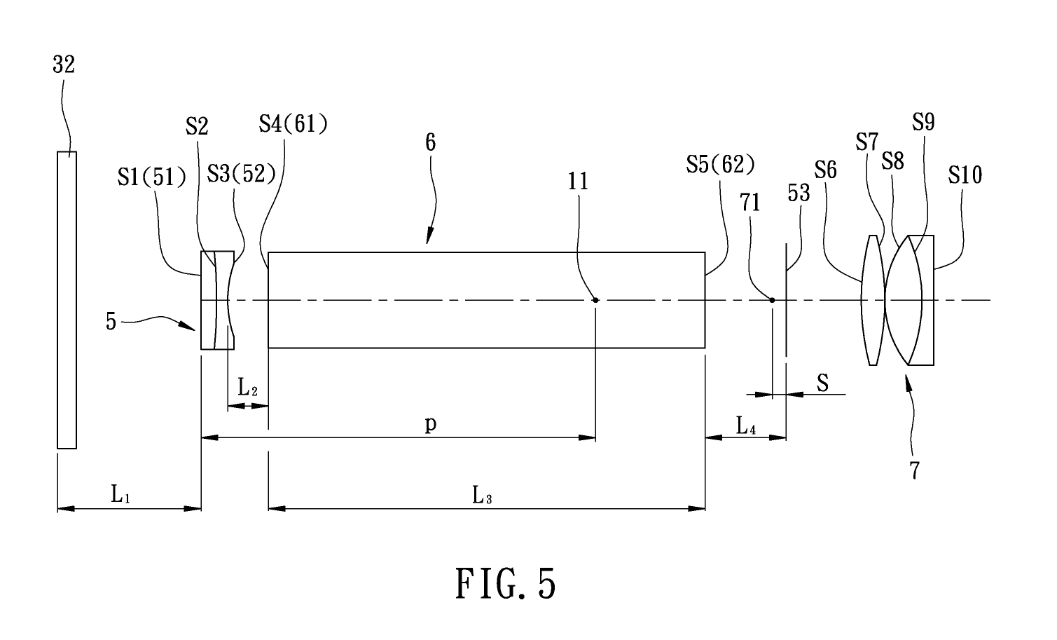

Referring to FIG. 5, the first lens set 5 has a negative optical power, and includes a plano-convex lens and a biconcave lens cemented to each other and arranged in sequence from an object side to an image side of the first lens set 5. The plano-convex lens has a convex surface facing the image side of the first lens set 5. The first lens set 5 has an object side surface 51 located at the plano-convex lens and an image side surface 52 located at the biconcave lens.

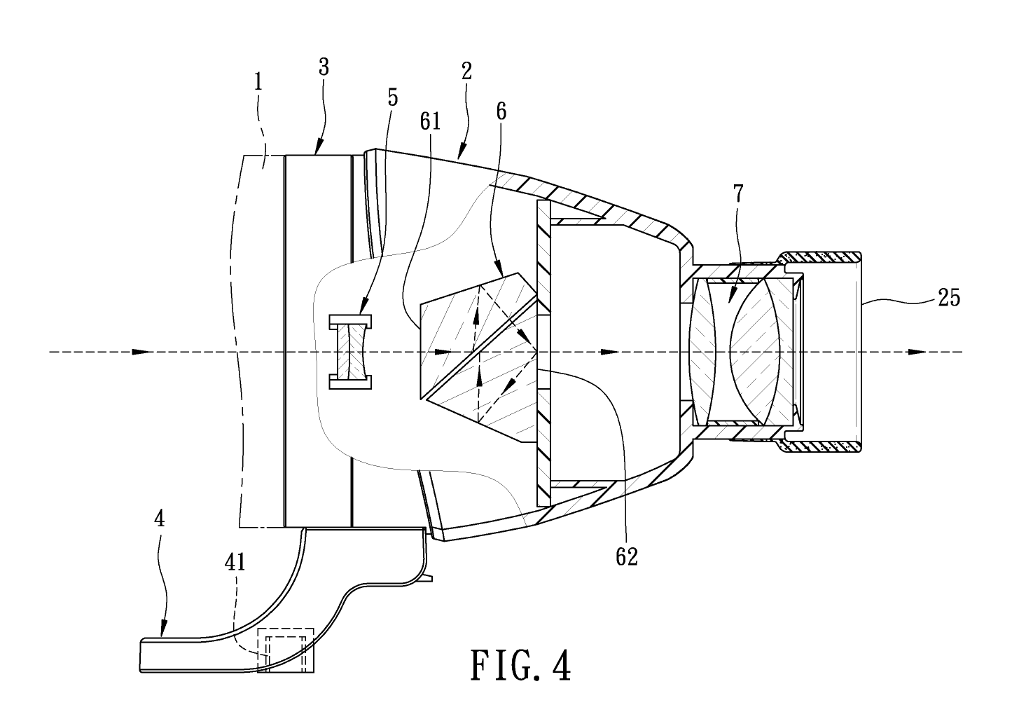

The prism unit 6 is located at the image side of the first lens set 5 in the housing 2. The prism unit 6 has a light-entrance surface 61 and a light-exit surface 62. An image formed by light beams exiting the light-exit surface 62 is erected with respect to an inverted image formed by light beams entering the light-entrance surface 61. In other words, the prism unit 6 is capable of rotating an image by 180°. Furthermore, referring to FIG. 4, the prism unit 6 is a Pechan prism. However, in a conventional optics simulation program, a thick optical plate having substantially the same optical path is adopted for alternative representation, such as a thick optical plate as shown in FIG. 5 for replacing the Pechan prism in this embodiment. Aside from image rotation function, the prism unit 6 provides a function of varying an observation viewing angle of the optical device.

It should be noted that prisms capable of rotating the image formed by light beams exiting the light-exit surface 62 with respect to the image formed by light beams entering the light-entrance surface 61 further include Schmidt-Pecham prisms, Double-Porro prisms, Abbe-Koenig prisms, etc. Since the various alternatives may be readily appreciated by those skilled in the art, further details of the same are omitted herein for the sake of brevity.

The second lens set 7 has a positive optical power, and is located at an image side of the prism unit 6 in the housing 2. The second lens set 7 includes a first biconvex lens, and a second biconvex lens and a plano-concave lens cemented to each other. The lenses are arranged in sequence from an object side to an image side of the second lens set 7. The plano-concave lens has a concave surface facing the object side of the second lens set 7.

Symbols shown in FIG. 5 are defined as follows: L₁ representing a distance from a lens contact surface of the camera lens bayonet 32 which is away from the first lens set 5 to the object side surface 51 of the first lens set 5, L₂ representing a distance from the image side surface 52 of the first lens set 5 to the light-entrance surface 61 of the prism unit 6, L₃ representing an optical path length from the light-entrance surface 61 to the light-exit surface 62 of the prism unit 6, L₄ representing a distance from the light-exit surface 62 of the prism unit 6 to an imaging plane 53 of a combination of the camera lens 1, the first lens set 5 and the prism unit 6, and p representing a distance from the object side surface 51 of the first lens set 5 to a camera lens imaging plane 11 of the camera lens 1. The camera lens imaging plane 11 is located within an optical path of the prism unit G.

It is worth to note that the imaging plane 53 of the combination of the camera lens 1, the first lens set 5 and the prism unit 6 is also the focal plane of the combination of the camera lens 1, the first lens set 5 and the prism unit 6 when the observed target is located at infinity position.

Table 1 illustrates parameters of the first preferred embodiment of the optical device according to the present invention.

TABLE 1

| | | Radius of | | Refractive |
|---|---|---|---|---|
| | Surface | Curvature | Thickness | Index/Abbe |
| | Number | (mm) | (mm) | Number |
| Camera Lens | | ∞ | −33.000 | |
| Imaging | | | | |
| Plane 11 | | | | |
| First Lens | S1 | ∞ | 3.000 | 1.805181/25.43 |
| Set 5 | | | | |
| | S2 | −54.880 | 2.000 | 1.516330/64.14 |
| | S3 | 20.450 | 7.810 | |
| PrismUnit 6 | S4 | ∞ | 83.000 | 1.516330/64.14 |
| | S5 | ∞ | 30.130 | |
| Second Lens | S6 | 54.880 | 4.000 | 1.620411/60.29 |
| set 7 | | | | |
| | S7 | −54.880 | 0.000 | |
| | S8 | 18.410 | 7.310 | 1.516330/64.14 |
| | S9 | −34.090 | 2.000 | 1.805181/25.43 |
| | S10 | ∞ | 20.000 | |
| Exit Pupil | | ∞ | 0.000 | |

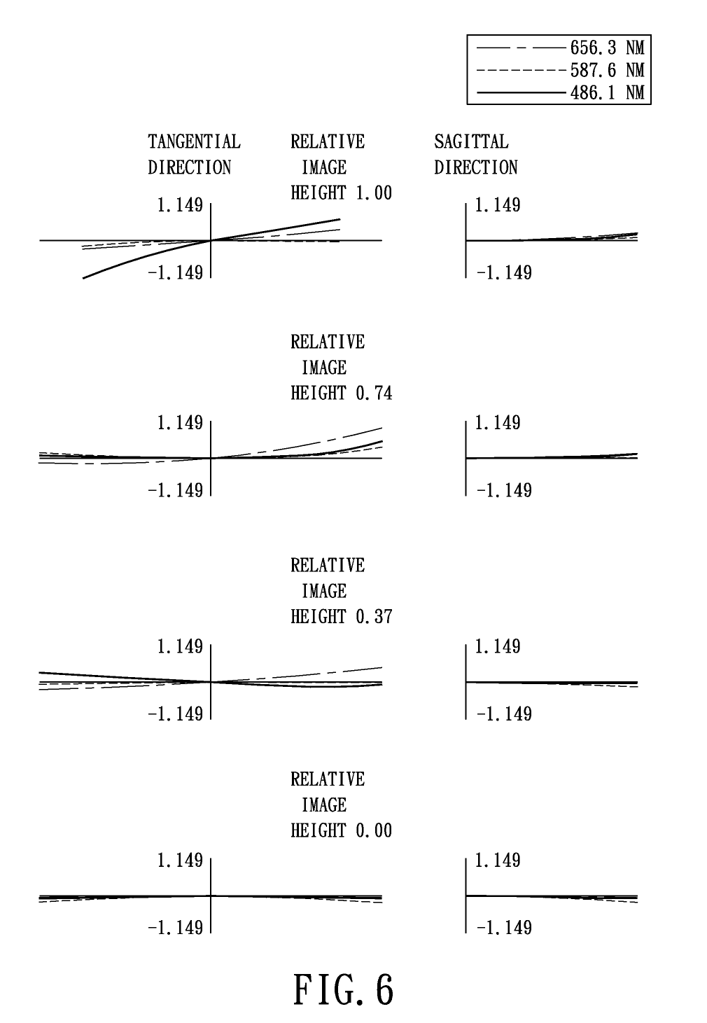

Referring to FIG. 6, ray fan plots of different wavelengths corresponding to different relative image heights are illustrated. Each relative image height has two ray fan plots each corresponding to a tangential direction and a sagittal direction, respectively. Aberrations of the first preferred embodiment corresponding to different relative image heights are illustrated in FIG. 6.

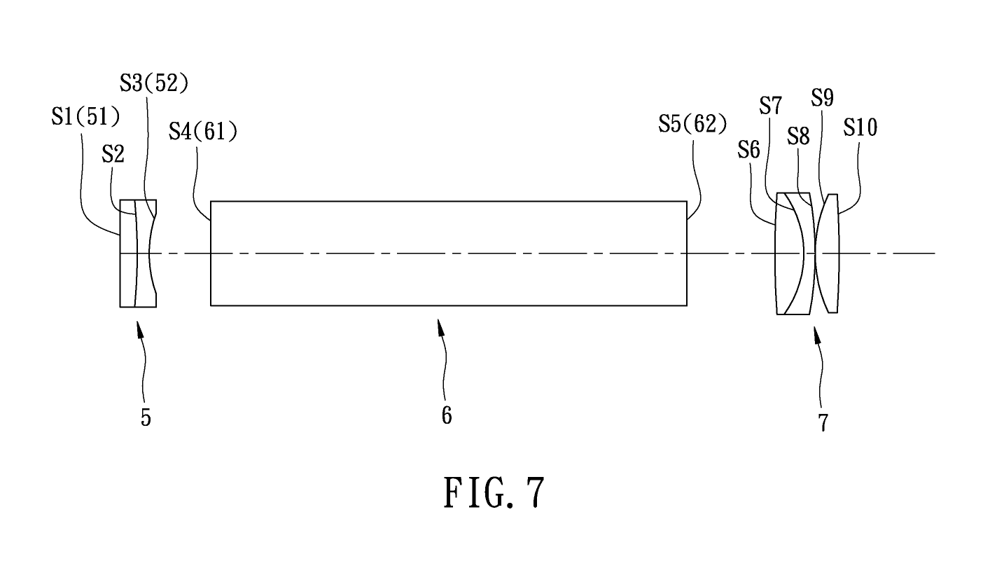

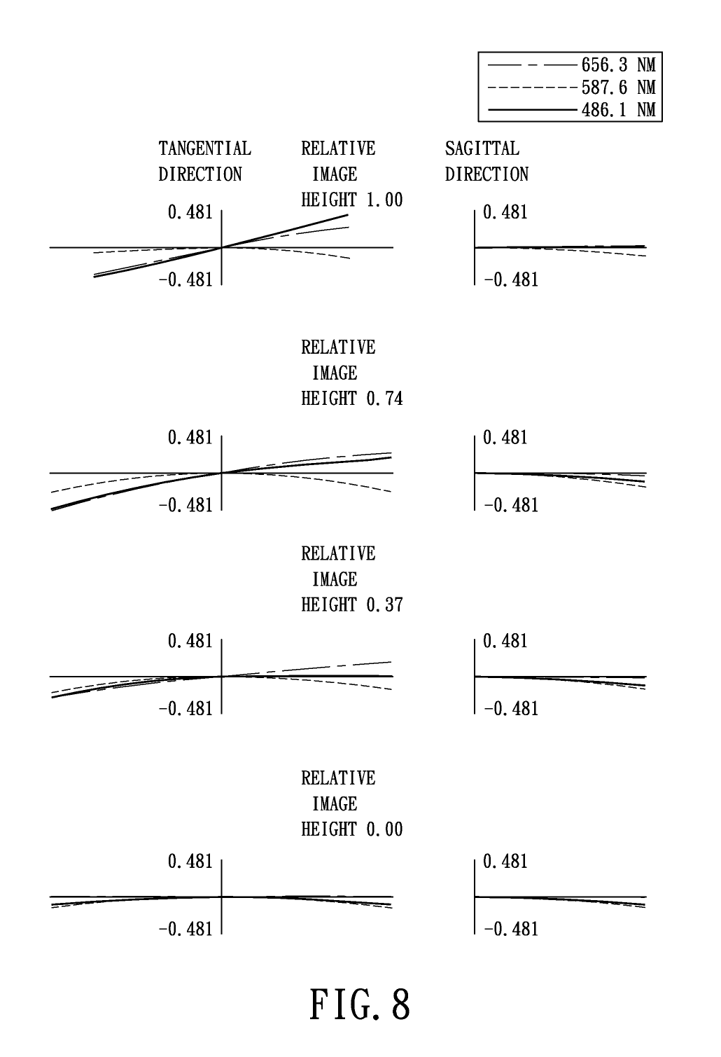

Referring to FIG. 7, a second preferred embodiment of the optical device for coupling to a camera lens so to form a visual observation system, according to the present invention, is illustrated. The second preferred embodiment differs from the first preferred embodiment in the configurations that the first lens set 5 includes a biconvex lens and a biconcave lens cemented to each other and arranged in sequence from the object side to the image side of the first lens set 5. The first lens set 5 has an object side surface 51 located at the biconvex lens and an image side surface 52 located at the biconcave lens. The second lens set 7 includes a first biconvex lens and a meniscus lens cemented to each other, and a second biconvex lens. The lenses are arranged in sequence from the object side to the image side of the second lens set 7. The meniscus lens has a concave surface facing the object side of the second lens set 7. Referring to FIG. 8, ray fan plots of the second preferred embodiment and of different wavelengths corresponding to different relative image heights are illustrated.

Table 2 illustrates parameters of the second preferred embodiment of the optical device according to the present invention.

TABLE 2

| | | Radius of | | Refractive |
|---|---|---|---|---|
| | Surface | Curvature | Thickness | Index/Abbe |
| | Number | (mm) | (mm) | Number |
| Camera Lens | | ∞ | −33.000 | |
| Imaging | | | | |
| Plane 11 | | | | |
| First Lens | S1 | 146.970 | 3.000 | 1.739887/27.15 |
| Set 5 | | | | |
| | S2 | −88.470 | 2.000 | 1.535665/69.59 |
| | S3 | 20.040 | 10.810 | |
| Prism Unit 6 | S4 | ∞ | 83.000 | 1.516800/6417 |
| | S5 | ∞ | 15.620 | |
| Second Lens | S6 | 144.030 | 5.000 | 1.772500/4962 |
| set 7 | | | | |
| | S7 | −17.380 | 2.000 | 1.846660/2378 |
| | S8 | −49.370 | 0.000 | |
| | S9 | 23.450 | 4.000 | 1.617739/5925 |
| | S10 | −201.380 | 22.000 | 1.739887/2715 |
| Exit Pupil | | ∞ | 0.000 | |

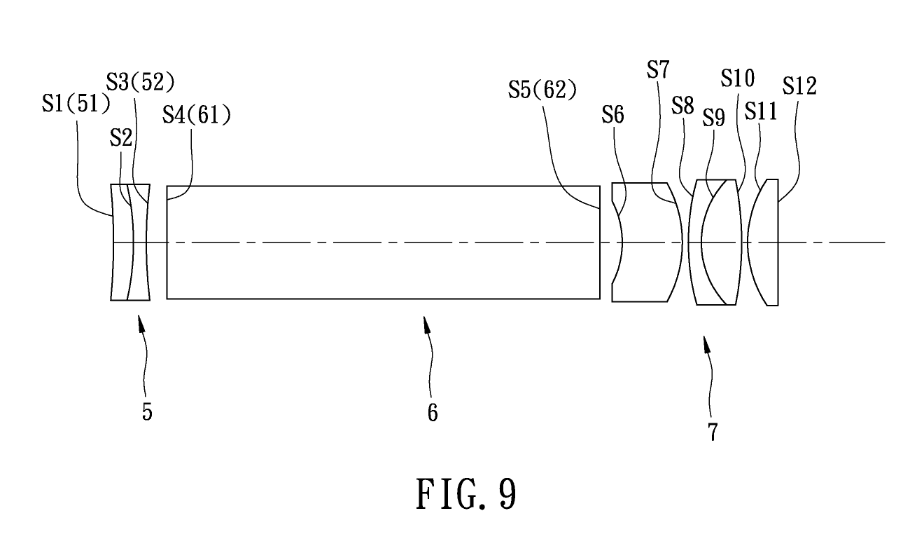

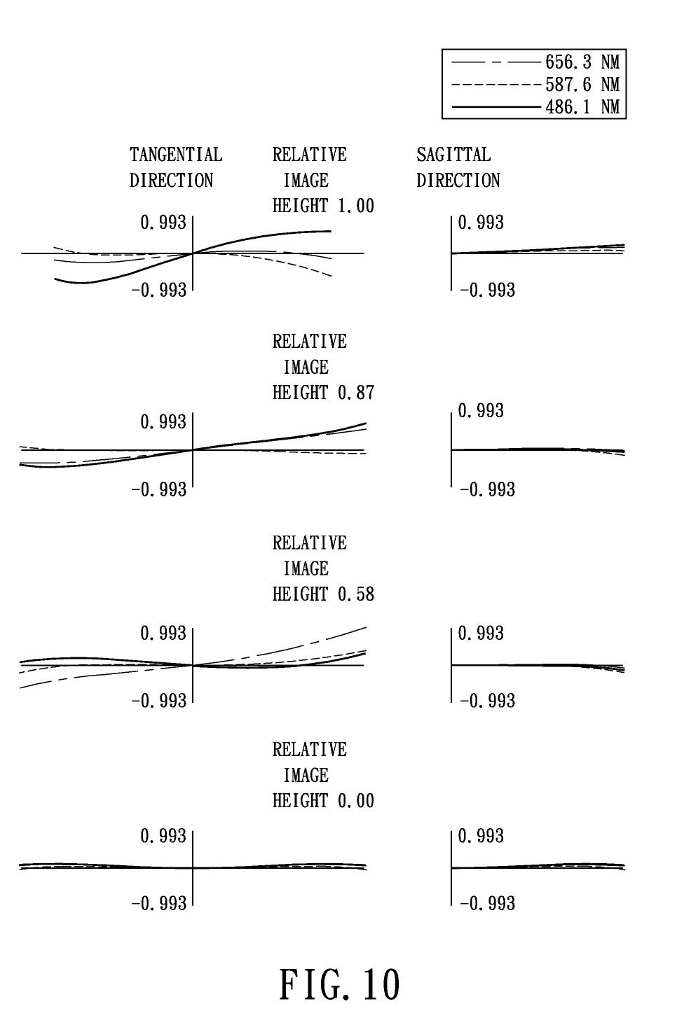

Referring to FIG. 9, a third preferred embodiment of the optical device for coupling to a camera lens to form a visual observation system, according to the present invention, is illustrated. The third preferred embodiment differs from the first preferred embodiment in the configurations that the first lens set 5 includes a first meniscus lens and a biconcave lens cemented to each other and arranged in sequence from the object side to the image side of the first lens set 5. The first meniscus lens has a concave surface facing the object side of the first lens set 5. The first lens set 5 has an object side surface 51 located at the first meniscus lens and an image side surface 52 located at the biconcave lens. The second lens set 7 includes a second meniscus lens, a third meniscus lens and a biconvex lens cemented to each other, and a plano-convex lens. The lenses are arranged in sequence from the object side to the image side of the second lens set 7. The second meniscus lens has a concave surface facing the object side of the second lens set 7. The third meniscus lens has a concave surface facing the image side of the second lens set 7. The plano-convex lens has a convex surface facing the object side of the second lens set 7. Referring to FIG. 10, ray fan plots of the third preferred embodiment and of different wavelengths corresponding to different relative image heights are illustrated.

Table 3 illustrates parameters of the third preferred embodiment of the optical device according to the present invention.

TABLE 3

| | | Radius of | | Refractive |
|---|---|---|---|---|
| | Surface | Curvature | Thickness | Index/Abbe |
| | Number | (mm) | (mm) | Number |
| Camera Lens | | ∞ | −38.000 | |
| Imaging | | | | |
| Plane 11 | | | | |
| First Lens | S1 | −167.90 | 3.000 | 1.828834/28.29 |
| Set 5 | | | | |
| | S2 | −42.48 | 2.000 | 1.558556/50.66 |
| | S3 | 69.01 | 3.000 | |
| PrismUnit 6 | S4 | ∞ | 64.000 | 1.516330/64.14 |
| | S5 | ∞ | 3.22 | |
| Second Lens | S6 | −13.35 | 8.77 | 1.753977/52.43 |
| set 7 | | | | |
| | S7 | −17.56 | 1.00 | |
| | S8 | 34.69 | 2.00 | 1.846663/23.62 |
| | S9 | 12.27 | 5.80 | 1.554346/64.35 |
| | S10 | −42.91 | 1.00 | |
| | S11 | 15.55 | 4.36 | 1.753978/52.43 |
| | S12 | ∞ | 15.00 | |
| Exit Pupil | | ∞ | 0.000 | |

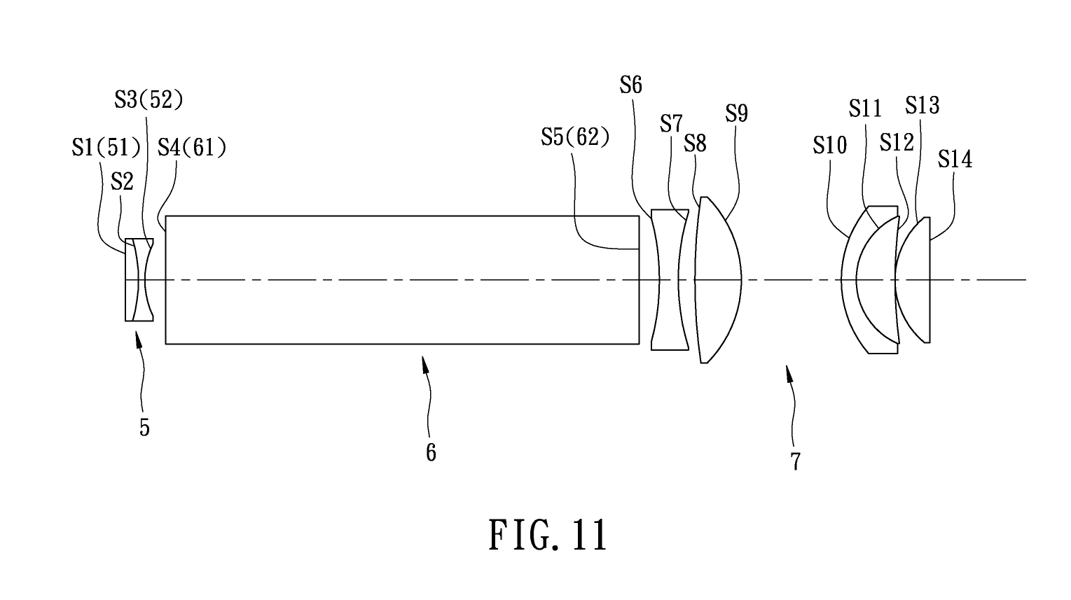

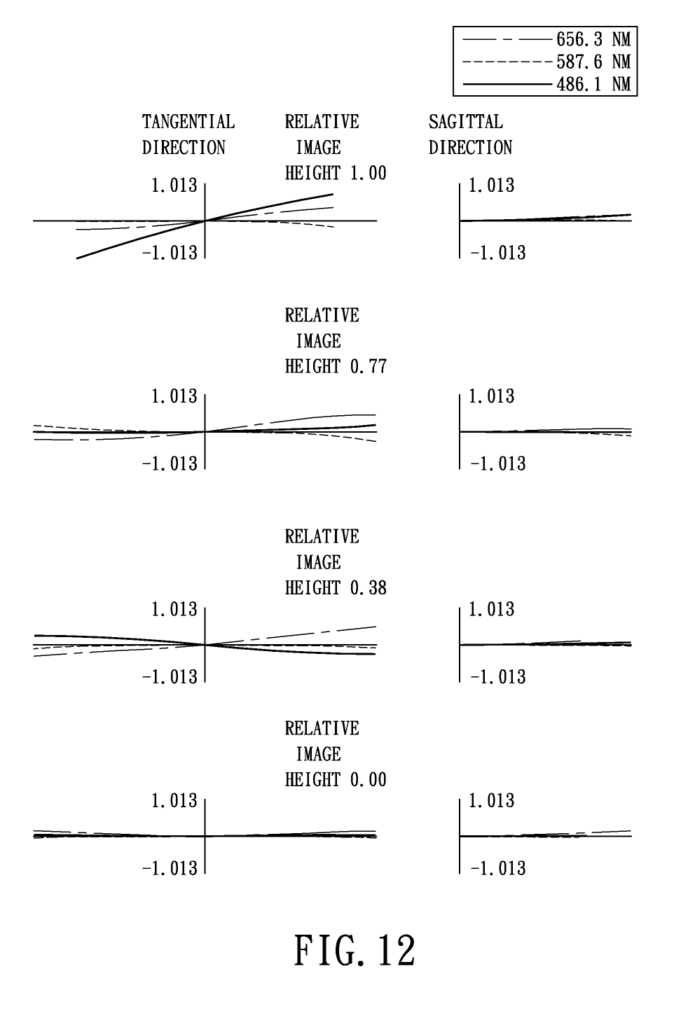

Referring to FIG. 11, a fourth preferred embodiment of the optical device for coupling to a camera lens to form a visual observation system, according to the present invention, is illustrated. The fourth preferred embodiment differs from the first preferred embodiment in the configurations that the second lens set 7 includes a biconcave lens, a biconvex lens, a first meniscus lens and a second meniscus lens cemented to each other, and a plano-convex lens. The lenses are arranged in sequence from the object side to the image side of the second lens set 7. Each of the first and second meniscus lenses has a concave surface facing the image side of the second lens set 7. The plano-convex lens has a convex surface facing the object side of the second lens set 7. Referring to FIG. 12, ray fan plots of the fourth preferred embodiment and of different wavelengths corresponding to different relative image heights are illustrated.

Table 4 illustrates parameters of the fourth preferred embodiment of the optical device according to the present invention.

TABLE 4

| | | Radius of | | Refractive |
|---|---|---|---|---|
| | Surface | Curvature | Thickness | Index/Abbe |
| | Number | (mm) | (mm) | Number |
| Camera Lens | | ∞ | −33.000 | |
| Imaging | | | | |
| Plane 11 | | | | |
| First Lens | S1 | ∞ | 3.074 | 1.805181/25.43 |
| Set 5 | | | | |
| | S2 | −42.106 | 2.000 | 1.583126/59.37 |
| | S3 | 20.181 | 5.013 | |
| PrismUnit 6 | S4 | ∞ | 120.000 | 1.516330/64.14 |
| | S5 | ∞ | 5.024 | |
| Second Lens | S6 | −55.966 | 4.666 | 1.805181/25.43 |
| set 7 | | | | |
| | S7 | 55.966 | 4.475 | |
| | S8 | 176.263 | 11.451 | 1.756998/47.82 |
| | S9 | −29.062 | 25.581 | |
| | S10 | 29.062 | 3.500 | 1.846660/23.78 |
| | S11 | 17.338 | 9.764 | 1.516330/64.14 |
| | S12 | 100.006 | 0.000 | |
| | S13 | 20.181 | 8.655 | 1.487490/70.24 |
| | S14 | ∞ | 20.000 | 1.805181/25.43 |
| Exit Pupil | | ∞ | 0.000 | |

By sorting the parameters of the first preferred embodiment to the fourth preferred embodiment, Table 5 is presented.

The first lens set 5 satisfies:

$$- 1.8 \leq \frac{( {R}_{2} + {R}_{1} )}{( {R}_{2} - {R}_{1} )} \leq - 0.2 , \qquad Eqaution 1$$

in which, R₁ represents a radius of curvature of the object side surface 51 of the first lens set 5, and R₂ represents a radius of curvature of the image side surface 52 of the first lens set 5. When the upper limit −0.2 is exceeded or when the lower limit −1.8 is not reached, the first lens set 5 may generate serious aberration resulting in poor imaging quality.

In order to prevent occurrence of interferences between the first lens set 5 and a lens of the camera lens 1 which is nearest to the optical device, or between the first lens set 5 and the camera lens bayonet 32 of the connecting unit 3, L₁ preferably satisfies:

3 mm<L₁<15 mm, Equation 2

in which, L₁ represents the distance from the lens contact surface of the camera lens bayonet 32 which is away from the first lens set 5 to the object side surface 51 of the first lens set 5.

The prism unit 6 satisfies:

d>p/4, Equation 3

60 mm<L₃<130 mm, Equation 4

in which, d represents a diameter of a largest inscribed circle of the light-entrance surface 61 of the prism unit 6, p represents the distance from the object side surface 51 of the first lens set 5 to the camera lens imaging plane 11 of the camera lens 1, and L₃ represents the optical path length from the light-entrance surface 61 to the light-exit surface 62 of the prism unit 6.

When L₃ exceeds the upper limit 130 mm, it may become difficult to design the first lens set 5, and optical flux of the prism unit 6 is reduced resulting from vignetting such that an observable angle thereof is narrowed. Moreover, an overly long optical device is unfavorable for miniaturization. When L₃ is lower than the lower limit 60 mm, since any kind of the aforementioned prisms, including the prism unit 6, must satisfy:

$$\frac{{L}_{3}}{d} = k ,$$

in which k is a corresponding constant value, a decrease in L₃ may result in a decrease in d such that the optical flux along an axis of the prism unit 6 is reduced, and thus optical flux of an overall system of the optical device is reduced.

The prism unit 6 further satisfies:

27 mm<p<44 mm, Equation 5

in which, p represents the distance from the object side surface 51 of the first lens set 5 to the camera lens imaging plane 11 of the camera lens 1. For all major specs of the camera lens 1 on the market, the camera lens imaging plane 11 is generally located at a distance of 42˜47 mm away from the camera lens 1. This distance corresponds to L₁+p. Since it has been known from Equation 2 that L₁ ranges from 3˜15 mm, p may be inferred as ranging from 27˜49 mm. Within this range, the camera lens imaging plane 11 of the camera lens 1 may be adjusted from a position within the optical path of the prism unit 6 to a position behind the optical path of the prism unit 6 by the first lens set 5.

The optical device of the present invention satisfies:

4 mm<L₂+L₄<25 mm, Equation 6

in which, L₂ represents the distance from the image side surface 52 of the first lens set 5 to the light-entrance surface 61 of the prism unit 6, and L₄ represents the distance from the light-exit surface 62 of the prism unit 6 to the imaging plane 53 of the combination of the camera lens 1, the first lens set 5 and the prism unit 6. When the upper limit 25 mm is exceeded, an observable angle of the optical device is overly narrowed, and a system length of the optical 2Q device is increased. When the lower limit 9 mm is not reached, the prism unit 6 is too close to the first lens set 5 and the second lens set 7 such that it is unfavorable for assembly and alignment of optical elements. More seriously, interferences among elements may even occur.

The optical device further satisfies:

$$\frac{- {f}_{2}^{2}}{250 mm} < S < 0 , \qquad Equation 7$$

in which, S represents a distance (unit: mm) from the imaging plane 53 of the combination of the camera lens 1, the first lens set 5 and the prism unit 6 to a front focal point 71 of the second lens set 7, and f₂ represents a focal length (unit: mm) of the second lens set 7. From Equation 7, it is apparent that S has a negative value range. This negative value means that the focal point 71 of the second lens set 7 is located closer to the object side relative to the imaging plane 53 of the combination of the camera lens 1, the first lens set 5 and the prism unit 6.

A system exit pupil of the second lens set 7 corresponds to a position of a human eye. For the purpose of enabling the second lens set 7 to image an object in the human eye which is located at a distance ranging from infinity to 250 mm away from the human eye so that the human eye may effectively focus and observe, the optical device should satisfy Equation 7 mentioned above.

TABLE 5

| Preferred | | | | |
|---|---|---|---|---|
| Embodiment | First | Second | Third | Fourth |
| R1 | ∞ | 146.970 | −167.90 | ∞ |
| R2 | 20.450 | 20.040 | 69.01 | 20.181 |
| (R2 + R1)/(R2 − R1) | −1 | −1.316 | −0.41 | −1 |
| L2 | 7.810 | 10.810 | 3.000 | 5.013 |
| L3 | 83.000 | 83.000 | 64.000 | 120.000 |
| L4 | 9.70 | −0.60 | 1.2868 | 14.20 |
| L2 + L4 | 17.51 | 10.21 | 5.931 | 19.21 |
| d | 18 | 18 | 16 | 30 |
| p | 33 | 33 | 38 | 33 |

In summary, by means of the first lens set 5, the position of the camera lens imaging plane 11 of the camera lens 1 is adjusted toward the image side, by means of the prism unit 6, the inverted image of the first lens set 5 is erected so as to facilitate observation by users, and by means of the second camera lens 7, the remote target image from the optical device and the camera lens 1 is magnified. Therefore, the optical device of the present invention may be coupled to the camera lens 1 so as to function as a visual observation system.

It should be noted that the second lens set 7 is equivalent to an eyepiece. The four preferred embodiments mentioned above all adopt a design that the second lens set 7 is directly disposed in the optical device of the present invention. However, the optical device of the present invention may only comprise the housing 2, the connecting unit 3, the tripod coupler 4, the first lens set 5 and the prism unit 6, and exclude the second lens set 7 from the design of the optical device in other embodiments of the invention. By adding a connecting structure to the housing 2, such as a thread or a sleeve, by coupling to the second lens set 7 in usage so that the second lens set 7 is to be located at the image side of the prism unit 6, and by satisfying Equation 7 mentioned above, the effect of observing remote objects is achieved. In this way, the optical device of the present invention which does not comprise the second lens set 7 may be adapted for coupling to different second lens sets. Since the second lens set 7 is equivalent to an eyepiece, the optical device of the present invention which does not comprise the second lens set 7 may match current eyepieces. By cooperation with the camera lens 1 and different eyepieces each having a corresponding focal length, an effect of enlarging remote targets by different magnifying powers may be achieved.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An optical device adapted for coupling to a camera lens so as to form a visual observation system, said optical device comprising:
a housing;
a connecting unit disposed at said housing and including a camera lens bayonet for connecting to the camera lens;
a first lens set disposed in said housing, and having a negative optical power;
a prism unit located at an image side of said first lens set in said housing, said prism unit having a light-entrance surface and a light-exit surface, an image formed by light beams exiting said light-exit surface being erected with respect to an inverted image formed by light beams entering said light-entrance surface; and
a second lens set located at an image side of said prism unit in said housing, said second lens set having a positive optical power;
said optical device satisfying:
3 mm<L₁<15 mm,
27 mm<p<44 mm
in which, L1 represents a distance from a lens contact surface of said camera lens bayonet which is away from said first lens set to an object side surface of said first lens set, and p represents a distance from said object side surface of said first lens set to a camera lens imaging plane of the camera lens, the camera lens imaging plane being located within an optical path of said prism unit.

2. The optical device as claimed in claim 1, wherein said first lens set satisfies:
$$- 1.8 \leq \frac{( {R}_{2} + {R}_{1} )}{( {R}_{2} - {R}_{1} )} \leq - 0.2$$
in which, R1 represents a radius of curvature of said object side surface of said first lens set, and R2 represents a radius of curvature of an image side surface of said first lens set.

3. The optical device as claimed in claim 1, wherein said optical device further satisfies:
4 mm<L₁+L₄<25 mm
in which, L2 represents a distance from an image side surface of said first lens set to said light-entrance surface of said prism unit, and L4 represents a distance from said light-exit surface of said prism unit to an imaging plane of a combination of the camera lens, said first lens set and said prism unit.

4. The optical device as claimed in claim 1, wherein said prism unit satisfies:
d>p/4,
60 mm<L₃<130 mm
in which, d represents a diameter of a largest inscribed circle of said light-entrance surface of said prism unit, p represents a distance from said object side surface of said first lens set to the camera lens imaging plane of the camera lens, and L3 represents an optical path length from said light-entrance surface to said light-exit surface of said prism unit.

5. The optical device as claimed in claim 1, wherein said optical device further satisfies:
$$\frac{- {f}_{2}^{2}}{250 mm} < S < 0 ,$$
in which, S represents a distance from an imaging plane of a combination of the camera lens, said first lens set and said prism unit to a front imaging plane of said second lens set, and f2 represents a focal length of said second lens set.

6. The optical device as claimed in claim 1, wherein said housing includes a plurality of first connecting parts, said connecting unit further including a ring body disposed at said housing, said camera lens bayonet being fastened to said ring body, said ring body including a plurality of second connecting parts corresponding in position to said first connecting parts, said second connecting parts being removably connected to said first connecting parts to secure removably said ring body to said housing.

7. The optical device as claimed in claim 1, further comprising a tripod coupler disposed at said housing, said tripod coupler including amount part for mounting said tripod coupler to a tripod, said mount part to be located between a center of gravity of said optical device and a center of gravity of the camera lens.

8. The optical device as claimed in claim 7, wherein said housing includes a housing engaging part, said tripod coupler further including a coupler engaging part corresponding in position to said housing engaging part, said coupler engaging part being removably connected to said housing engaging part to secure removably said tripod coupler to said housing.

9. An optical device adapted for coupling to a camera lens and a second lens set so as to form a visual observation system, the second lens set having a positive optical power, said optical device comprising:
a housing;
a connecting unit disposed at said housing and including a camera lens bayonet for connecting to the camera lens;
a first lens set disposed in said housing, and having a negative optical power and
a prism unit located at an image side of said first lens set in said housing, said prism unit having a light-entrance surface and a light-exit surface, an image formed by light beams exiting said light-exit surface being erected with respect to an inverted image formed by light beams entering said light-entrance surface,
said optical device satisfying:
3 mm<L₁<15 mm,
27 mm<p<44 mm,
in which, L1 represents a distance from a lens contact surface of said camera lens bayonet which is away from said first lens set to an object side surface of said first lens set, and p represents a distance from said object side surface of said first lens set to a camera lens imaging plane of the camera lens, the camera lens imaging plane being located within an optical path of said prism unit.

10. The optical device as claimed in claim 9, wherein said first lens set satisfies:
$$- 1.8 \leq \frac{( {R}_{2} + {R}_{1} )}{( {R}_{2} - {R}_{1} )} \leq - 0.2$$
in which, R1 represents a radius of curvature of said object side surface of said first lens set, and R2 represents a radius of curvature of an image side surface of said first lens set.

11. The optical device as claimed in claim 9, wherein said optical device further satisfies:
4 mm<L₂+L₄<25 mm
in which, L2 represents a distance from an image side surface of said first lens set to said light-entrance surface of said prism unit, and L4 represents a distance from said light-exit surface of said prism unit to an imaging plane of a combination of the camera lens, said first lens set and said prism unit.

12. The optical device as claimed in claim 9, wherein said prism unit satisfies:
d>p/4,
60 mm<L₃<130 mm
in which, d represents a diameter of a largest inscribed circle of said light-entrance surface of said prism unit, p represents a distance from said object side surface of said first lens set to the camera lens imaging plane of the camera lens, and L3 represents an optical path length from said light-entrance surface to said light-exit surface of said prism unit.

13. The optical device as claimed in claim 9, wherein said optical device further satisfies:
$$\frac{- {f}_{2}^{2}}{250 mm} < S < 0 ,$$
in which, S represents a distance from an imaging plane of a combination of the camera lens, said first lens set and said prism unit to a front imaging plane of the second lens set, and f2 represents a focal length of the second lens set.

14. The optical device as claimed in claim 9, wherein said housing includes a plurality of first connecting parts, said connecting unit further including a ring body disposed at said housing, said camera lens bayonet being fastened to said ring body, said ring body including a plurality of second connecting parts corresponding in position to said first connecting parts, said second connecting parts being removably connected to said first connecting parts to secure removably said ring body to said housing.

15. The optical device as claimed in claim 9, further comprising a tripod coupler disposed at said housing, said tripod coupler including a mount part for mounting said tripod coupler to a tripod, said mount part to be located between a center of gravity of said optical device and a center of gravity of the camera lens.

16. The optical device as claimed in claim 15, wherein said housing includes a housing engaging part, said tripod coupler further including a coupler engaging part corresponding in position to said housing engaging part, said coupler engaging part being removably connected to said housing engaging part to secure removably said tripod coupler to said housing.
